(19) United States
(12) Patent Application Publication
(10) Pub. No.: US 2006/0032133 A1
(43) Pub. Date: Feb. 16, 2006

(54) Protective elastic sleeve

(76) Inventors: Veijo Matias Tuoriniemi, Summit, NJ (US); Cornelia Frances Tuoriniemi, Summit, NJ (US)

Correspondence Address: VEIJO M. TUORINIEMI, 47 WOODLAND AVE., APT 107, SUMMIT, NJ, 07901, US

(21) Appl. No.: 11/191,330

(22) Filed: Jul. 27, 2005

Related U.S. Application Data
(60) Provisional application No. 60/591,633, filed on Jul. 28, 2004.

(51) Int. Cl. A47G 7/08; A01G 13/02

(52) U.S. Cl. 47/72; 47/31

(57) ABSTRACT

A method of isolating plant potting material from humans and animals, comprising: Having a pot with a bottom and a wall extending vertically upwards from the bottom, and an open top. The pot is containing soil and a plant which extends vertically upwards from the soil. A porous elastic sleeve having an opening on at least one end of the sleeve is stretchied over the wall of the pot. The sleeve is extending along the wall until a partial length of the sleeve, including said opening, extends above an upper edge of the pot. The above-the-upper-edge-extending sleeve is released over the top of the pot, so that a perimeter of opening recovers towards an unstretched perimeter of said opening, to thereby at least partially cover said open top of the pot and restricts access to the potting material.

### FIELD OF INVENTION

Present invention relates to elastic net protecting the soil and other potting material in a plant, flower or tree receptacle from children and pets from digging soil by covering the area between the upper edge of the pot and the stem of the plant.

### BACKGROUND OF THE INVENTION

When infants start learning to walk they are looking for support from from all kind of objects locating home. Flower and plant pots are very popular, since they are on the right hight and often heavy enough to give great support. However when holding themselves in upright position they also find playing with the soil in the pot exciting. Soon or later the soil is spread to the surroundings. We avoided this dilemma with our daughter Frances and older son Andrew, since when they were young we lived on Manhattan and didn't have space for plants standing on the floor. However, our youngest son John learned to walk in New Jersey where we had several plants, so we had to figure out something. John just not only spread the soil all over but also like to eat it.

Present invention would also protect the plant and soil from household animals, pets like cats and dogs from digging the soil.

Net also prevents dropped leaves from sticking into potting soil. It can easily be shaked clean or cleaned with vacuum cleaner. The net can also be placed in an outward sloped position so that the dropped sleeves will slide down the net, out from the net.

### CROSS REFERENCE TO RELATED APPLICATIONS

U.S. Pat. No. 4,706,411 issued Nov. 17, 1987 for Bo Lövqvist is made of two decomposing parts, one under the ground and second above the ground. The plant quard covers the whole plant including branches and leaves, protecting the plant against insect attacts.

U.S. Pat. No. 4,750,292 Granted for Mauritz Alstig of Östersund Sweden in Jun. 14, 1988 describes a hose-like net, protecting plants against pest attact. It has a cotton bottom part which is forming a casing around the root parts and continuing as polyamide net above the ground covering the rest of the plant. The net is burried under ground with the root ball and rest of the net is covering the stem, branches and leaves of the plant. Alstigs invention is preventing pine weevil and other pathogenic insects from attacking newly planted trees in forest industry where esthetic values are not inportant and the whole plant could be covered. However, it present invention is not covering branches and leaves. It is also characterized that Alstigs net prevents insects to get in, but as reverse, the present invention is characterized to prevent from the soil to be gigged out.

U.S. Pat. No. 4,977,703 Dec. 18, 1990 relates to an improved plant soil protector. The improved plant soil protector includes a plurality of segments made from a grid-like material which permit the passage of air, water and fertilizer therethrough while protecting the soil from pets or the like. Additionally, each of the segments includes means which permit the segments, when joined together, to adapt to different sized plants as well as different sized pots.

U.S. Pat. No. 4,995,192 issued Feb. 26, 1991 is a cone shaped cover preventing rainwater from getting in to the flower pot and giving plant owner the cabability to control the moisture conditions of the plant soil.

U.S. Pat. No. 5,058,317 Oct. 22, 1991 is a mulch collar for installation around a stem of a plant. The mulch collar comprises a web of relatively thin, pliable material having an opening for accommodating the stem of the plant and a slit extending from the opening to a peripheral edge of the web.

U.S. Pat. No. 5,065,543 Nov. 19, 1991 is a tree guard mat is made from flexible fiber ropes or fibrous strips arranged in concentric rings to form a mat on top of the soil.

U.S. Pat. No. 5,171,390 for Robert J. Travers Dec. 15, 1992 is a pland base cover, liner which is intented to be placed inside of the plant pot, on top of the soil.

U.S. Pat. No. 5,184,421 Feb. 9, 1993 describes a pot cover covers the dirt in a flower pot, and locks to the pot to prevent scattering of the dirt and to prevent access by a small child or pet. The pot cover is a disk that is normally flat.

U.S. Pat. No. 5,425,204 Jun. 20, 1995 is an open mesh plant soil protector apparatus includes a first half-cover assembly which includes a first open mesh portion adapted to cover an approximately first half of a quantity of soil in a potted plant and a second open mesh portion adapted to cover an approximately second half of a quantity of soil in a potted plant.

U.S. Pat. No. 5,548,923 Aug. 27, 1996 describes an adjustable collar apparatus and method to encircle a post or botanical item at its base, which collar apparatus comprises a plurality of at least three separate, identical, flat sheet panel elements.

U.S. Pat. No. 5,918,411 Jul. 6, 1999 is a plant protector constructed and arranged to provide a protective cover on the surface of the ground around a plant, formed of two identical separate semicircular half-sections which interlock at diametrically extending center wall sections to form a bowl-like structure with an upstanding outer wall, a flat bottom with drain openings, a center opening extending into each half-section to accommodate a plant stem, and an outer skirt depending from an upper edge of the outer wall.

U.S. Pat. No. 6,061,953 May 16, 2000 discloses a potted plant protector device comprising a base, arms and fingers extending therefrom in a generally dome-shaped pattern is provided.

U.S. Pat. No. 6,640,490 B1 Nov. 4, 2003 describes a plant-protection mat, particularly in the form of a perforated disk which, in the use position above the root bale of a plant, is intended as soil covering. The perforated disk is formed from a coconut fiber nonwoven having coconut fibers bonded by latex.

U.S. Pat. No. 6,705,044 B2 Mar. 16, 2004 describes an adjustable landscaping ergonomic pads of various shapes adapted for covering the soil around the trunks of shrubs, trees, and garden plants to completely eliminate and retard the growth of weeds and other undesirable plants.

### SUMMARY OF THE INVENTION

Even if several different ways to protect the soil has been developed they all lack the flexibility, simplicity, cost effectivity, adaptivity and security of the present invention.

Presenly described invention describes a a method of isolating plant potting material from humans and animals, comprising steps of providing a pot with a bottom, a wall extending vertically upwards from the bottom, and an open top; the pot containing potting material and a plant which extends vertically upwards from the potting material. providing a porous elastic sleeve having an opening on at least one end of the sleeve; stretching said opening of the sleeve over the wall of the pot, and extending said sleeve along said wall until a partial length of the sleeve, including said opening, extends above an upper edge of the pot; and releasing said length of the elastic sleeve over the top of the pot so that a perimeter of said opening recovers towards an unstretched perimeter of said opening, to thereby at least partially cover said open top of the pot and restrict access to the potting material.

The porous elastic sleeve can be made of net fabric, knotted net, mesh fabric, fish net fabric, or extruded out of polymeric material. It can also made of cutting out of tubular elastic material.

Elastic properties can be archieved by providing elastic structures or by using elastic material like spandex or rubber.

Pores in the porous material are sufficiently large to allow water to readily pass through for purposes of watering the plant, but small enough to prevent toddlers or pets from digging the soil.

### BRIEF DESCRIPTION OF SEVERAL VIEWS OF THE DRAWINGS

FIG. 1 Protective elastic tubular sleeve with two open ends.

FIG. 2 Protective elastic tubular sleeve covering the walls of the pot and the top opening of the pot. Our 1 yo old son John trying to access soil in the pot in 2004.

FIG. 3 Protective elastic tubular sleeve with one open end and a second closed end.

FIG. 4 Protective elastic sleeve of FIG. 3 covering top opening of the pot at least partially and covering the whole bottom and the sides of the pot.

FIG. 5 Protective fish net sleeve manufactured by S. Thygesen AS covering the top of the receptacle.

FIG. 6 Tightening cord securing the top opening of the tubular sleeve around the plant.

FIG. 7 Protective sleeve protecting the soil between a tree guard and the tree.

FIG. 8 Nett structured fabric by Fablok Mills, Style 8846

FIG. 9 Extruded net structure # SW600-22 by Niagara Caps and Plugs Inc.

FIG. 10 Extruded Nett Structure # SW600-22 by Niagara Caps and Plugs Inc. Over a 13″ diameter Plant Pot

### DETAILED DESCRIPTION OF THE INVENTION

This application claims priority from U.S. provisional application “Protective Elastic Net”, application No. 60/591,633, filed Jul. 28, 2004, fully incorporated as reference herein.

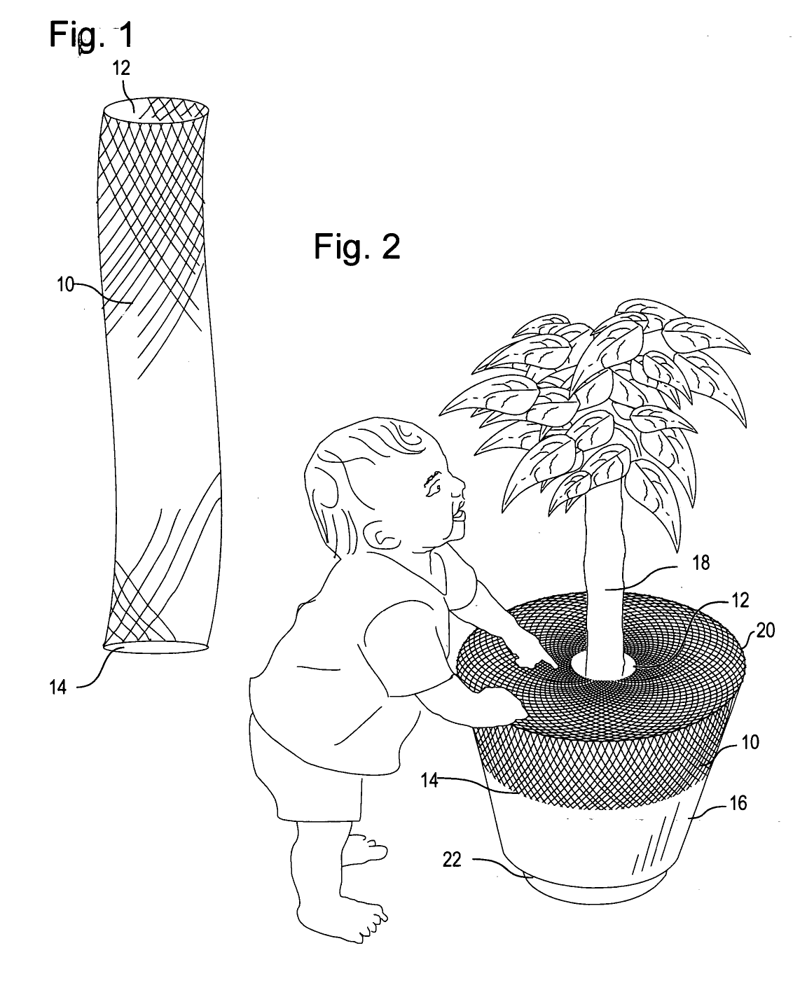

FIG. 1 shows a protective elastic sleeve 10 having a continuous preferably uniform tubular form. The sleeve 10 is made of porous material which includes knotted, woven or knitted net fabric, fish net or mesh fabric with holes or pores or any other fabric or polymeric material with pores extending through the sleeve material and being sized as follows.

The pores should be sufficiently small to prevent todlers fingers and pets pavs from making physical contact with the potting material, but preferably are sufficiently large so as to allow water to readily pass through for purposes of watering the plant.

If the netting were too small the water would stay on top of the net without penetrating through, If the opening were big, it would give a grip for a child to pull the net.

“Sleeve” as used herein has two ends, either one or both of which can be open. Sleeve may comprise spandex or other elastic material combined with other fibers, such as polyamide, to impart different aesthetic appearances, strengt or durability to the sleeve as will be apparent to those of ordinary skill in the art based on the present specification.

Preferably the net is made out of elastic knit with a circular knitting machine or elastic fish net with rachel knitting machine. The tubular knit is cut in pieces having predetermined length, determined by first opening 12 and a second opening 14.

When the sleeve 10 in FIG. 2 is stretched over a receptacle 16 for a plant, flower or tree for holding growing, freshly cut, or imitation vegetation, the top part of the net 10 which is reaching above the top edge 20 and consisting the first opening 12, will gradually return to its initial relaxed form having initial diameter closelly around the plant 18 or will adapt itself around the plant. When adapting around the plant the excess sleeve might form a neck around the trunk on the tree.

The elastic net will cover the area between the top edge 20 of the flowerpot 16 and the plant 18 protecting the soil or other potting material. Potting material can include soil, rocks, moss, mulch or other material used in potting plants.

Preferably the protective elastic net would be so long that the second opening 14 would well reach the bottom 22 the receptacle 16 and would relax itself under the receptacle and be secured there and hold its place by the weight of the receptacle 16 (not shown). However, since the net is held in its place by tension and friction, it might be sufficient to cover the walls only partially as shown in FIG. 2.

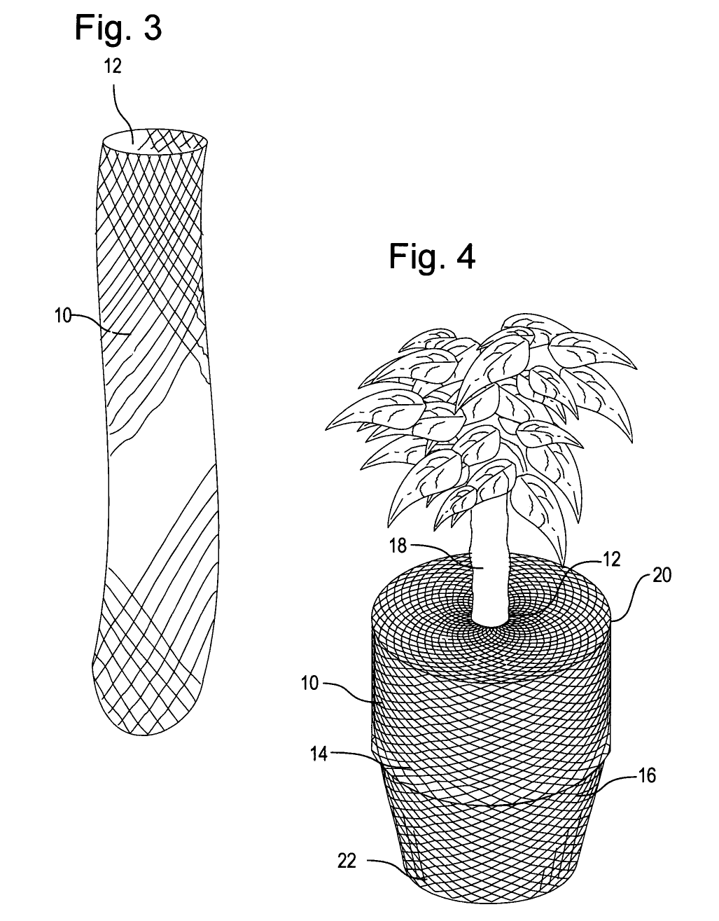

In FIG. 3 the sleeve 10 is having only one opening 12 in the first end having the second end closed to form a tubular sock to secure the sleeve 10 under the pot 16.

Forming a tubular sock can be programmed in a tubular e.g. circular knitting machine or the bottom opening 14 can be closed by seaming.

FIG. 4 shows how tubular sock is covering the whole bottom 22 and the vertical wall of the pot 16

A woven knit, or knotted material of open texture with evenly spaced holes at regular intervals can be uniform in every part of the protective elastic net.

However, if desired, a part of the net structure can variate in form or size in order to save in material, to change properties, or form a decorative pattern.

For example the part of the net which is covering the vertical side of the pot can have bigger mesh or net openings than the part of the net which covers the area between the top edge 20 of the flowerpot 16 and the plant 18 to save in material. (Not shown)

If the sleeve would have bigger opening area, the receptacles own decorative color and possible paterns would show better through the net. In this case it is desirable that the net would be as invisible as possible.

In some case the net can have a decorative feature of it's own. If desired the net can also be woven or knitted to a decorative form, e.g. a lace.

In the FIG. 6 the the top part of the net 10, consisting the first opening 12 has been provided with a tightening cord 26, which has been secured by a knot

Fabric Structure Providing Elastic Property

Some structures of knit and woven fabric provide the elastic properties themselves. For example commonly in clothing industry used Jersey knit is elastic sideways and lengthwise. However, for the present invention it would be desirable to choose a knit or a type of woven fabric, which would not unravel or run if the yarn would become accidently broken. Many types of this open net lock stitch constructed fabrics are known in the industry, exspecially hosiery industry and industry specialized in mesh or net-type facrics and manufacturing of fishing nets.

The fabric is preferably knitted in a circular knitting or rachel knitting machine having a tubular form straight from the machine, but it can also be an elastic flat fabric constructed in tubular form by joining opposite edges by seaming them together.

By using a machine making tubular fabric manufacture will reach advantage, since one seam, which would be needed if the tube would be made of flat fabric, will be saved.

Different size of protective tubular elastic nets can be made to fit different size receptacles.

Knotted netting is provided by several manufacturers, Sterling Net and Twine Co., Inc of Montclair, N.J. and Fukui North America of Eganville Canada among many others. Fukui North America also offers Rachel Knotless Netting from size 3/16″ up. Even smaller open areas are available.

FIG. 8 shows a knitted net 38. Apex Mills in Inwood N.Y. and Fablok Mills in New New Providence, N.J. and Jason Mills Inc, Westwood N.J. manufacture different type of knitted net and mesh for example.

Fibre Providing Elactic Property

“Sleeve” as used herein has two ends, either one or both of which can be open.

Often an elastic fabric is made of yarns containing an elastic material. For example spandex is used in rib knits to provide improved strechability.

Lycra ® spandex by DuPond company Invista was the first manufactured elastic fiber introduced by 1958. Lycra spandex can stretches up to 600 times its length, and recovers back to its original size.

Transparent or colorless spandexes like Lycra™ have also desirable property not to cover the surface or minimally cover the surface of a plant receptacle and therefore also provide a discreet soil cover and protector on the top of the plant pot. Discreet appearance can also reached by selecting thinner yarns and using thinner mech qualities.

Often Spandexes are blended with other natural or manmade yarn to reach desired yarn and fabric properties. If extreme elasticity and strechability were needed, it would be desirable to use spandex fibre alone in a structurally stretchable type of knit or weave.

By counting only on the elasticity of the structure of the fabric one can reach stretchability from 1 inch relaxed diameter to 3-4 inch stretched diameter. In some cases this relation might be enough to form a protective net. However if higher elasticity is needed the use of elastic fibers in yarn or fabric structure is desirable. By combining elastic fabric structure and using elastic yarn, 1-inch diameter to 6-inch diameter and even higher relations between relaxed and fully stretched tubular fabric can be reached.

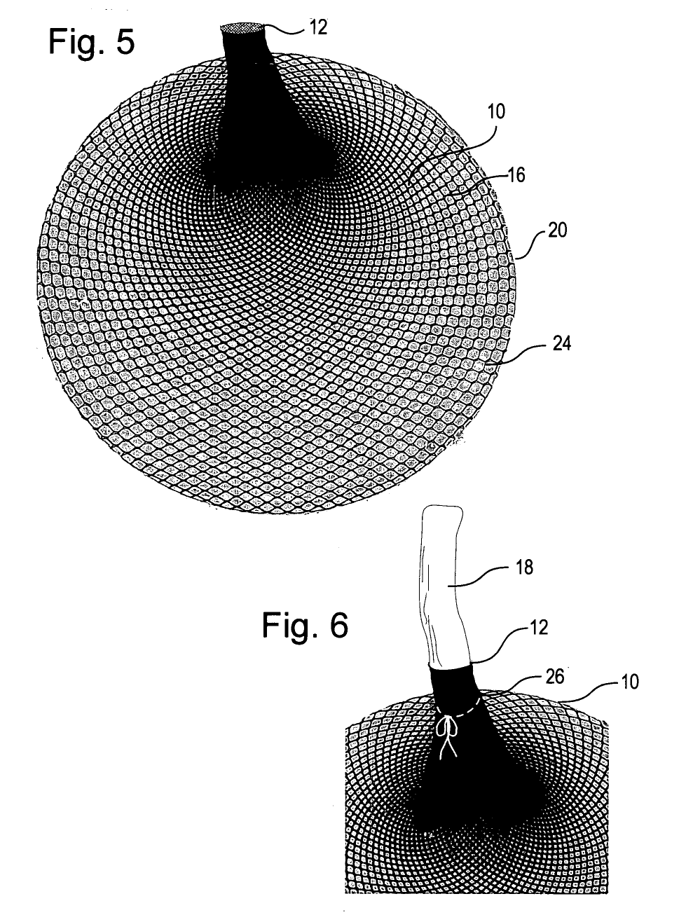

S. Thygesen AS from Ikast, Denmark produces fish net type article no. 51004 which contains 88% Polyamide and 12% Lycra® or generic spandex. This fish net fabric provides ideal unraveling property. Tubular net can be made in different sizes. The net can streched about six times from its original unstretched stage and it can recover back to almost its original relaxed sixe as shown in FIG. 5. From unrelaxed size as shown in opening 12 the net can stretch over the top edge 20 od a receptacle.

Medical industry uses extremelly stretchable tubular elastic dressing retainer. One of them is manufactured by Western Medical Ltd and sold under trademark BandNet®. BandNet® is a tubular poly covered nylon and rubber stretch net. Open net lock-stitch construction prevents unraveling or running when cuts are made.

Surgilast® fron the same manufacturer is a tubular stretch net made from high quality nylon and rubber mix the construction of this net does not unravel or run and can be cut without seaming the edge.

Non-Woven Net

Porous material also includes cutted or extruded sleeves made of polymeric materials.

Alternativelly the protective elastic net can be made of netting which is formed by extrusion of polymeric material like nia-guard™ light-duty netting made by Niagara Caps & Plugs. 7090 Edinboro Road, Erie, Pa., 16509-4497, USA.

The structure of extruded sleeve is shown in FIG. 9. FIG. 10 shows extruded net adapted to cover soil in the plant pot.

Niagara Caps and plugs provide netting made of different polymeric materials, like Polyethylene, polypropylene, Ethylene Vinyl Acetate, Nylon, Thermoplastic Rubber and Vinyl. Tensile Strength of these materials variates between 50-12000 P.S.I. Elongation % of the materials mentioned above varies between from 15% to 800%. By using extrusion methot and elastic polymeric materials, very useful netting can be created.

Ramifications and Scope

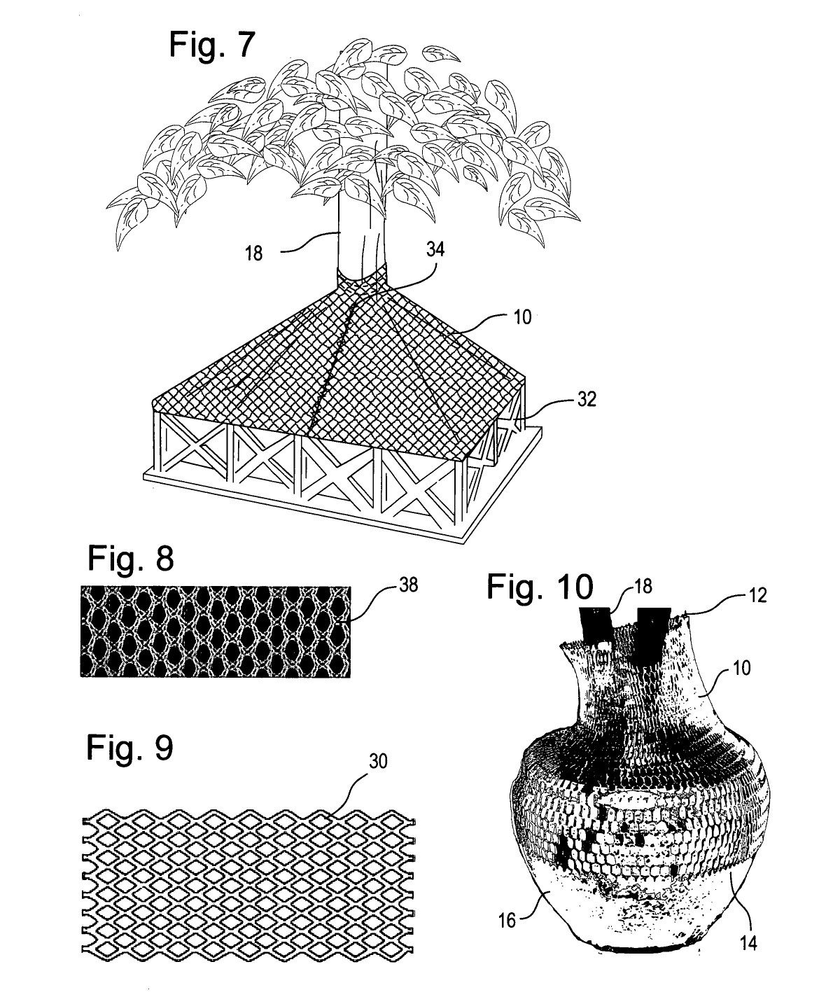

Plants can be houseplants, or plants outside in the parks or on the sidewalks. In FIG. 7 is shown how in cities, e.g. in New York the trees on the sidewalk have a one to two feet high fence 32 surrounding the tree and protecting the tree and the soil. The present invention can also be adabted to protect the soil from dogs and other animals from digging in the soil and also to prevent people to through trash under the tree. The sleeve 10 can be placed around the tree trunk when the tree is planted and then streched over the soil and secured around the fence surrounding the tree.

In order to getting the net around bigger, existing trees the net sleeve might have to be cut open 34 from the side, then wrapped around the tree and the cutted edges re-joined together and then stretched over the soil around the tree.

The elastic net can be streched to a vertical position between the top of the fence and the tree, or it can be stretched to form a sloped tent which would prevent the leaves and trash from collecting on the top of the net.

Small pots and plants can be covered by lifting the pot and stretching the net and pulling it over the bottom of the pot.

With heavy plants and pots, user should place the netting over the pot before planting and filling the pot with potting soil.

We claim:

1. A method of isolating plant potting material from humans and animals, comprising:
a) providing a pot with a bottom, a wall extending vertically upwards from the bottom, and an open top; the pot containing potting material and a plant which extends vertically upwards from said potting material;
b) providing a porous elastic sleeve having an opening on at least one end of the sleeve;
c) stretching said opening of the sleeve over the wall of the pot, and extending said sleeve along said wall until a partial length of the sleeve, including said opening, extends above an upper edge of the pot; and
d) releasing said length of the elastic sleeve over the top of the pot so that a perimeter of said opening recovers towards an unstretched perimeter of said opening, to thereby at least partially cover said open top of the pot and restrict access to the potting material.

2. The method of claim 1, wherein the porous elastic sleeve is a net fabric.

3. The method of claim 1, wherein the porous elastic sleeve is knotted net.

4. The method of claim 1, wherein the porous elastic sleeve is mesh fabric.

5. The method of claim 1, wherein the porous elastic sleeve is fish net.

6. The method of claim 1, wherein the porous elastic sleeve is extruded from a polymeris material.

7. The method of claim 1, wherein the porous elastic sleeve is made of rubber at least partially.

8. The method of claim 1, wherein the porous elastic sleeve is made of spandex at least partially.

9. The method of claim 1, wherein the porous elastic sleeve is extruded out of polymeric material

10. The method of claim 1, wherein said partial length of the sleeve is sufficiently high so as to allow the sleeve to extend vertically around the stem of the plant to form a neck around said stem.

11. The method of claim 1, wherein said releasing comprises releasing said length of the elastic sleeve so that said opening closely surrounds the stem of the plant.

12. The method of claim 1, wherein pores in the porous material are sufficiently large to allow water to readily pass through for purposes of watering the plant.

13. A protective porous elastic sleeve for isolating plant potting material from humans and animals, comprising:
a) a porous elastic sleeve having an opening on at least one end of the sleeve;
b) said opening of the sleeve being stretchable over the wall of a pot, which pot has a bottom, a wall extending vertically upwards from the bottom, an open top and which pot contains potting material and a plant which extends vertically upwards from said potting material,
c) the sleeve being extendable along said wall until a partial length of the sleeve, including said opening, extends above an upper edge of the pot; and
d) said length of the elastic sleeve being releasable over the top of the pot so that a perimeter of said opening is recoverable towards an unstretched perimeter of said opening, to thereby at least partially cover said open top and restrict access to the potting material.
